(19) United States
(12) Patent Application Publication
(10) Pub. No.: US 2018/0220329 A1
(43) Pub. Date: Aug. 2, 2018

(54) System and Methods for Improving Performance in a Multi-SIM Wireless Communication Device Using Voice-Over-Wireless Local Area Network Service

(71) Applicant: QUALCOMM Incorporated, San Diego, CA (US)

(72) Inventors: Bhaskaran Arumugam, Hyderabad (IN); Akash Srivastava, Hyderabad (IN); Pankaj Bansal, Jaipur (IN); Hardeepsinh Jadeja, Hyderabad (IN); Sumit Kumar, Hyderabad (IN); Ravi Kanth Kotreka, Hyderabad (IN); Harinath Reddy Patel, Mahabubnagar (IN); Naresh Babu Vungarala, Hyderabad (IN)

(21) Appl. No.: 15/418,681

(22) Filed: Jan. 28, 2017

(51) Int. Cl. H04W 28/04; H04L 29/06; H04B 17/318; H04W 52/02; H04W 68/02

(52) U.S. Cl. CPC H04W 28/044; H04L 63/0853; H04W 76/048; H04W 52/0203; H04W 68/02; H04B 17/318

(57) ABSTRACT

A multi-subscriber identification module (SIM) wireless communication device with a first SIM and a second SIM associated with a shared radio frequency (RF) resource may determine that timing collisions are predicted between an active period of a discontinuous reception (DRX) cycle associated with the first SIM and an active period of a DRX cycle associated with the second SIM. In response, the wireless communication device may determine whether the first SIM is registered with an IP Multimedia Subsystem (IMS) to use Voice-over-wireless local area network (VoWLAN) service over a wireless local area network (WLAN). If the first SIM is registered with the IMS to use VoWLAN service over the WLAN, the wireless communication device may shift the conflicting DRX cycle associated with the first SIM by a time margin, and receive paging messages for mobile terminating calls on the modem stack associated with the first SIM over the WLAN.

### BACKGROUND

Multi-subscriber identity module (SIM) wireless communication devices have become increasing popular because of their flexibility in service options and other features. One type of multi-SIM wireless communication device, a multi-SIM multi-standby (MSMS) wireless communication device (e.g., a dual-SIM dual-standby (DSDS) device), enables two SIMs to be in idle mode waiting to begin communications, but only allows one SIM at a time to participate in an active communication due to sharing of a single radio frequency (RF) resource (e.g., a transceiver). Other multi-SIM devices may extend this capability to more than two SIMs and may be configured with any number of SIMs greater than two (i.e., multi-SIM multi-standby wireless communication devices).

Wireless communication networks (referred to simply as “wireless networks” herein) are widely deployed to provide various communication services such as voice, packet data, broadcast, messaging, and so on. Wireless networks may be capable of supporting communication for multiple users by sharing the available network resources. Such sharing of available network resources may be implemented by networks using one or more multiple-access wireless communications protocols, such as Time Division Multiple Access (TDMA), Code Division Multiple Access (CDMA), and Frequency Division Multiple Access (FDMA). These wireless networks may also utilize various radio technologies, including but not limited to Global System for Mobile Communications (GSM), Universal Mobile Telecommunications System (UMTS), CDMA2000, Advanced Mobile Phone Service (AMPS), General Packet Radio Services (GPRS), Long Term Evolution (LTE), High Data Rate (HDR) technology (e.g., 1×EV technology), etc.

For example, various multimedia services in LTE are provided by an IP Multimedia Subsystem (IMS), including voice-over-wireless local area network (WLAN), such as voice-over-Wi-Fi network. Voice-over-WLAN service enables voice calling to be provided over a WLAN instead of using other data networks (e.g., voice-over-IP, voice-over-LTE, etc.).

Since an MSMS wireless communication device typically uses a single RF resource to communicate over the multiple SIMs and/or networks, the device actively communicates using a single SIM and/or network at a given time. For example, while one SIM is participating in active communication on a particular network, the second SIM may be in idle mode camped on a serving cell of the same or different network. Further, the RF resource is typically used to support both SIMs when both are in idle mode. Specifically, each SIM using discontinuous reception (DRX) in idle mode remains in a sleep state (“inactive period”) to conserve power and avoid using the RF resource, with periodic entry into an awake state (“active period”) to in order to perform various idle mode tasks. However, when both SIMs are in idle mode, there is a significant chance for persistent collisions to occur in decoding the paging channel due to conflicting active periods, thereby degrading performance for receiving information broadcast on the paging channel In this manner, performance for receiving mobile terminating calls for each idle mode SIM on the wireless device will be degraded.

In addition to the capability of communicating via wireless telephony networks, modern wireless communication devices typically also include the capability of communicating via wireless local area networks (WLAN), such as wireless networks using the Wi-Fi communication protocol. Such WLANs enable wireless communication devices to communicate with the Internet using standard Internet protocols (IP). Such Internet communications may support voice over IP (VoIP) communications.

### SUMMARY

Systems, methods, and devices of various of various embodiments improve operations of wireless communication devices having a first subscriber identity module (SIM) and a second SIM associated with a shared radio frequency (RF) resource by shifting an active period of a discontinuous reception (DRX) cycle associated with one or both SIMs when Voice-over-wireless local area network (VoWLAN) service over a wireless local area network (WLAN) is available for one of the SIMs.

Various embodiments may include determining whether timing collisions are predicted between an active period of a DRX cycle associated with the first SIM and an active period of a DRX cycle associated with the second SIM, and determining whether the first SIM is registered with an IP Multimedia Subsystem (IMS) to use VoWLAN service over a WLAN in response to determining that timing collisions are predicted between the active period of the DRX cycle associated with the first SIM and the active period of the DRX cycle associated with the second SIM. Various embodiments may further include shifting the conflicting DRX cycle associated with the first SIM by a time margin and receiving paging messages for mobile terminating calls on the modem stack associated with the first SIM over the WLAN in response to determining that the first SIM is registered with the IMS to use VoWLAN service over the WLAN.

Some embodiments may further include decoding a paging channel of the first serving network according to the shifted DRX cycle on the modem stack associated with the first SIM, and monitoring a paging channel of the second serving network according to the DRX cycle associated with the second SIM. Some embodiments may further include determining whether signal strength for at least one of the WLAN and the first serving network is above a corresponding threshold in response to determining that the first SIM is registered with the IMS to use the VoWLAN service. Such embodiments may further include implementing a power saving scheme on the modem stack associated with the first SIM in response to determining that signal strength for at least one of the WLAN and the first serving network is above a corresponding threshold.

In some embodiments, implementing the power saving scheme may include identifying a modification period associated with the first serving cell, calculating a number of shifted DRX cycles within the modification period, and decoding a paging channel of the first serving network only during a last shifted DRX cycle of each modification period on the modem stack associated with the first SIM. In some embodiments, implementing the power saving scheme may include determining whether a notification of a change in system information is received on the paging channel of the first serving network. Some embodiments may further include invalidating current system information for the first serving network once a new modification period is started and receiving new system information from the first serving network in response to determining that a notification of the change in system information is received.

In some embodiments, implementing the power saving scheme may include identifying a modification period associated with the first serving network, and determining whether the first SIM has established an RRC connection with the first serving network. In some embodiments, implementing the power saving scheme may include, decoding, on the modem stack associated with the first SIM, a system information block includes a system information update tag from the first serving cell after a new modification period has started and comparing a value of the system information update tag from the decoded system information block to a current value stored in the wireless communication device in response to determining that the first SIM has established an RRC connection with the first serving network.

Some embodiments may further include determining whether the value of the system information update tag from the decoded system information block is different than the current value in response to determining that the first SIM has established an RRC connection with the first serving network. Some embodiments may further include invalidating current system information for the first serving network on the modem stack associated with the first SIM and reacquiring system information from the first serving network on the modem stack associated with the first SIM in response to determining that the value of the system information update tag from the decoded system information block is different than the current value.

In some embodiments, the WLAN may be a Wi-Fi network. In some embodiments, the first serving network and the second serving network may each support communications using at least Long Term Evolution (LTE), in which the first network is different from the second network. Some embodiments may further include developing the time margin dynamically over time based on a minimum time shift required to avoid performance degradation in decoding paging messages on either the modem stack associated with the first SIM or the modem stack associated with the second SIM.

Various embodiments include a wireless communication device configured to use at least a first subscriber identity module (SIM) and a second SIM associated with a shared RF resource, and including a processor configured with processor-executable instructions to perform operations of the methods summarized above. Various embodiments also include a non-transitory processor-readable medium on which is stored processor-executable instructions configured to cause a processor of a wireless communication device to perform operations of the methods summarized above. Various embodiments also include a wireless communication device having means for performing functions of the methods summarized above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features herein.

FIG. 1A is a communication system block diagram of a communication network suitable for use with various embodiments.

FIG. 1B is system block diagram of a network architecture suitable for use with various embodiments.

FIG. 2 is a block diagram illustrating a wireless communication device according to various embodiments.

FIG. 3 is a system architecture diagram illustrating example protocol layer stacks implemented by the wireless communication device of FIG. 2.

FIG. 4 is a process flow diagram illustrating a method for using Voice-over-wireless local area network (VoWLAN) capability to avoid performance degradation for idle mode SIMs in a MSMS wireless communication device according to various embodiments.

FIG. 5 is a process flow diagram illustrating another method for using VoWLAN capability to avoid performance degradation for idle mode SIMs in a MSMS wireless communication device according to various embodiments.

FIG. 6 is a component diagram of an example wireless device suitable for use with various embodiments.

FIG. 7 is a component diagram of another example wireless device suitable for use with various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments enable wireless communication devices to use a voice-over-WLAN (VoWLAN) capability associated with at least one of two or more SIMs whose subscription is in the idle mode so as to avoid persistent collisions of active periods of that subscription with another subscription operating in the idle mode. In various embodiments, a subscription registered with an IP Multimedia Subsystem (IMS) for VoWLAN may shift a discontinuous reception (DRX) cycle o by a time margin, thereby creating a shifted DRX cycle that avoids collisions with the other subscription.

As used herein, the terms “SIM” and “subscriber identity module” are used interchangeably to refer to a memory that may be an integrated circuit or embedded into a removable card, and that stores an International Mobile Subscriber Identity (IMSI), related key, and/or other information used to identify and/or authenticate a wireless device on a network and enable a communication service with the network. Because the information stored in a SIM enables the wireless device to establish a communication link for a particular communication service or services with a particular network, the term “SIM” is also be used herein as a shorthand reference to the communication service associated with and enabled by the information stored in a particular SIM as the SIM and the communication network, as well as the services and subscriptions supported by that network, correlate to one another. Similarly, the term SIM may also be used as a shorthand reference to the protocol stack and/or modem stack and communication processes used in establishing and conducting communication services with subscriptions and networks enabled by the information stored in a particular SIM.

As used herein, the terms “multi-SIM wireless communication device,” “multi-SIM wireless device,” and “dual-SIM wireless communication device,” are used interchangeably to describe a wireless device that is configured with more than one SIM and allows idle-mode operations to be performed on two networks simultaneously, as well as selective communication on one network while performing idle-mode operations on at least one other network. Dual-SIM dual-standby (DSDS) communication devices are an example of a type of MSMS communication devices.

The terms “wireless network,” “cellular network,” and “cellular wireless communication network” are used interchangeably herein to refer to a portion or all of a wireless network of a carrier associated with a wireless device and/or subscription on a wireless device.

Wireless communication networks are widely deployed to provide various communication services such as voice, packet data, broadcast, messaging, and so on. These wireless networks may be capable of supporting communications for multiple users by sharing the available network resources. Examples of such wireless networks include the Global System for Mobile Communications (GSM), Code Division Multiple Access (CDMA) networks, Time Division Multiple Access (TDMA) networks, and Frequency Division Multiple Access (FDMA) networks. Wireless networks may also utilize various radio technologies such as Wideband-CDMA (W-CDMA), CDMA2000, Global System for Mobile Communications (GSM), etc. While reference may be made to procedures set forth in GSM standards such references are provided merely as examples, and the claims encompass other types of cellular telecommunication networks and technologies.

Modern mobile communication devices (e.g., smartphones) may each include one or more SIMs containing SIMs that enable a user to connect to different mobile networks while using the same mobile communication device. Each SIM serves to identify and authenticate a subscriber using a particular mobile communication device, and each SIM is associated with only one subscription. For example, a SIM may be associated with a subscription to one of GSM, TD-SCDMA, CDMA2000, and WCDMA.

As used herein, the term “RF resource” refers to the components in a wireless communication device that send, receive and decode radio frequency signals. An RF resource typically includes a number of components coupled together that transmit RF signals that are referred to as a “transmit chain,” and a number of components coupled together that receive and process RF signals that are referred to herein as a “receive chain.”

While specific receiver operations may be described herein with reference to a degree of two (i.e., two RF resources, two antennas, two receive chains, etc.), such references are used as example and are not meant to preclude embodiments using three or more RF resources. The terms “receiver” and/or “transmitter” may respectively indicate a receive chain and/or transmit chain, and/or portions thereof in use for radio links. Such portions of the receive chain and/or transmit chain may be parts of the RF resource that include, without limitation, an RF front end, components of the RF front end (including a receiver unit and/or transmitter unit), antennas, etc. Portions of a receive chain and/or transmit chain may be integrated into a single chip, or distributed over multiple chips. Also, the RF resource, or the parts of the RF resource, may be integrated into a chip along with other functions of the wireless device. Further, in some embodiment wireless systems, the wireless communication device may be configured with more RF resources than spatial streams, thereby enabling receive and/or transmit diversity to improve signal quality.

As used herein, the terms “power-saving mode,” “power-saving-mode cycle,” “discontinuous reception,” and “DRX cycle” are used interchangeably to refer to an idle mode process that involves alternating sleep periods (during which power consumption is minimized) and awake (or “wake-up”) periods (in which normal power consumption and reception are returned and the wireless device monitors a channel by normal reception). The length of a power-saving-mode cycle, measured as the interval between the start of a wake-up period and the start of the next wake-up period, is typically signaled by the network.

Typically, each SIM of a multi-SIM wireless communication device stores subscriber identity information that supports a subscription with a mobile network operator. Mobile networks may use a plurality of radio access technologies (RATs) to support wireless communications with subscribers, and modern wireless communication devices are typically configured to support wireless communications via a multiple RATs. For example, a SIM that enables a subscription that supports communications with a mobile network operator using the GSM RAT may also support communications with the network using the WCDMA and LTE RATs. The ability to communicate using different RATs enables wireless communication devices to support a broad range of network services.

Modern wireless communication devices also typically include radios that enable communications via WLAN RATs, such as Wi-Fi. Various multimedia services in LTE may be provided by an IP Multimedia Subsystem (IMS), including Voice-over-WLAN (VoWLAN), such as Voice-over-Wi-Fi (VoWi-Fi)). VoWLAN enables voice-based IP services, such as Voice-over-LTE (VoLTE), to be provided over a WLAN.

In a MSMS wireless communication device, the SIMs may be configured to implement DRX, with the RF resource supporting both SIMs in idle mode. Depending on the radio access technology of the serving networks, such idle modes may involve implementing a power saving cycle that includes sleep and awake states (e.g., a DRX cycle).

Each SIM using DRX cycles in idle mode may remain in a sleep state (“inactive period”) to conserve power and avoid using the RF resource, with periodic entry into an awake state (“active period”) to in order to perform various idle mode tasks. Such idle mode tasks may include, for example, decoding a paging channel of the serving network to receive pages for mobile terminating calls, system information changes, and messages from the Earthquake and Tsunami Warning Service (ETWS) and Commercial Mobile Alert System (CMAS), as well performing signal measurements, cell reselection, etc. The timing of the active period for a particular idle mode SIM may be for a paging group to which idle mode SIM belongs by the serving network. The duration of a complete idle mode DRX cycle (measured as the interval between the start of consecutive active periods) for LTE and WCDMA may be 640 ms or a multiple thereof (e.g., 1280 ms). The duration of a complete idle mode DRX cycle for GSM may be a multiple of 235 ms*n, where “n” is an integer in the range of 2-9. Therefore, when both SIMs are in idle mode, there may be a significant chance of persistent collisions in decoding the paging channel due to conflicting active periods. As a consequence, performance for receiving mobile terminating calls for each idle mode SIM on the wireless device may be degraded.

Various embodiments may use a voice-over-WLAN (VoWLAN) capability associated with at least one of the idle mode SIMs to avoid persistent collisions of active periods with another idle mode SIM. Specifically, pages for mobile terminating calls to the first idle mode SIM may be received over a WLAN (e.g., a Wi-Fi network), which is independent of timing associated with the serving network's DRX cycle. While the first idle mode SIM (or modem stack associated with the first idle mode SIM operations) is still required to decode the paging channel of the serving network in order to perform other idle mode tasks, such information is typically broadcast throughout the DRX cycle. Therefore, in various embodiments, if DRX cycles associated with two idle mode SIMs conflict such that persistent collisions are between their respective active periods are predicted, the wireless communication device may detect whether at least one of the idle mode SIMs is registered with IMS to use VoWLAN service. If at least one SIM is registered with IMS for VoWLAN, the wireless communication device may shift the DRX cycle of one such SIM by a time margin, creating a shifted DRX cycle.

By shifting the DRX cycle of a subscription registered with IMS for VoWLAN, the wireless communication device may avoid persistent collisions without impacting performance. That is, in various embodiments, the overlap between active periods of the DRX cycles may be avoided, while pages for mobile terminating calls and system information for each SIMs may still be received. In some embodiments, the time margin may be a predetermined value, or may be developed dynamically over time as the minimum time shift needed to avoid page decode performance degradation. In some embodiments, the time margin value may be configurable by the wireless communication device and/or by a serving network.

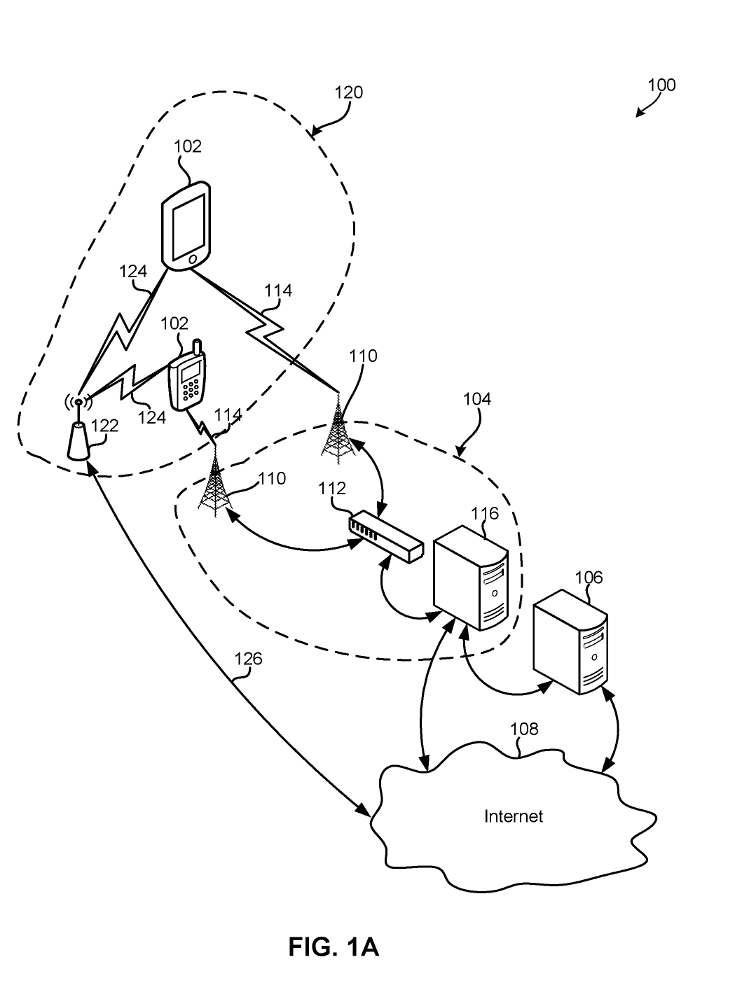

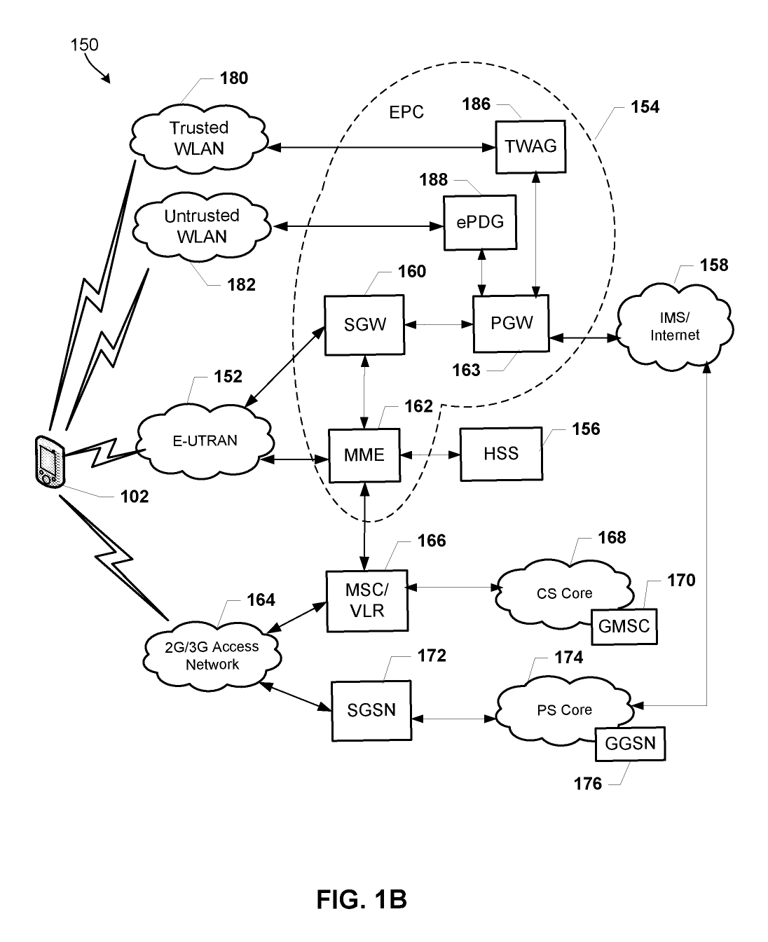

Various embodiments may be implemented within a variety of communication systems, such as the example communication system 100 illustrated in FIG. 1A. The communication system 100 may include one or more wireless communication devices 102 in communication with a telephone network 104 and a wireless local area network (WLAN) 120.

The WLAN 120 may include a wireless access point 122 (e.g., a Wi-Fi “hotspot”) that is coupled to the Internet. The wireless access point 122 supports wireless communication links 124 (e.g., Wi-Fi signals) with wireless communication devices 102 that within communication range and logged into the access point. The access point 122 relays packetized communication packets (e.g., TCP/IP packets) between the wireless communication devices 102 and the Internet, typically via wired (or fiber optic) networks 126, which may include an Internet service provider or “ISP” (not shown). The wireless communication links 124 provided by the wireless access point 122 constitute the WLAN 120, although in some references the term WLAN may encompass the connected wireless communication devices 102.

The telephone network 104 may include network servers 106 coupled to the telephone network 104 and to the Internet 108. A typical telephone network 104 may include a plurality of cell base stations 110 coupled to a network operations center 112, which operates to connect voice and data calls between the wireless communication devices 102 (e.g., cellular phones, tablets, laptop computers, etc.) and other network destinations, such as via telephone land lines (e.g., a POTS network, not shown) and the Internet 108. The telephone network 104 may also include one or more servers 116 coupled to or within the network operations center 112 that provide a connection to the Internet 108 and/or to the network servers 106. Communications between the wireless communication devices 102 and the telephone network 104 may be accomplished via two-way wireless communication links 114, such as GSM, UMTS, EDGE, fourth generation (4G), 3G, CDMA, TDMA, LTE, and/or other communication technologies.

Upon power up, the wireless communication device 102 may search for wireless networks from which the wireless communication device 102 can receive communication service. If a WLAN 120 is detected, the wireless communication devices 102 may exchange handshaking messages with a wireless access point 122 to establish a WLAN communication link 124. The wireless communication device 102 may also search for wireless telephony networks. The wireless communication devices 102 may be configured to prefer LTE networks when available by defining a priority list in which LTE frequencies occupy the highest spots.

The wireless communication device 102 may perform registration processes on one of the identified networks (referred to as the serving network), and the wireless communication device 102 may operate in a connected mode to actively communicate with the serving network. Alternatively, the wireless communication device 102 may operate in an idle mode and camp on the serving network if active communication is not required by the wireless communication device 102. In the idle mode, the wireless communication device 102 may identify all radio access technologies (RATs) in which the wireless communication device 102 is able to find a “suitable” cell in a normal scenario or an “acceptable” cell in an emergency scenario, as specified in the LTE standards, such as 3GPP TS 36.304 version 8.2.0 Release 8, entitled “LTE; Evolved Universal Terrestrial Radio Access (E-UTRA); User Equipment (UE) procedures in idle mode.”

The wireless communication device 102 may camp on a cell belonging to the RAT with the highest priority among all identified. The wireless communication device 102 may remain camped until either the control channel no longer satisfies a threshold signal strength or a cell of a higher priority RAT reaches the threshold signal strength. Such cell selection/reselection operations for the wireless communication device 102 in the idle mode are also described in 3GPP TS 36.304 version 8.2.0 Release 8.

FIG. 1B illustrates a network architecture 150 that includes an Evolved Packet System (EPS). With reference to FIGS. 1A-1B, in the network architecture 150 the wireless communication device 102 may be connected to an LTE access network, for example, an Evolved UMTS Terrestrial Radio Access Network (E-UTRAN) 152. In the various embodiments, the E-UTRAN 152 may be a network of LTE base stations (i.e., eNodeBs) (e.g., 110 in FIG. 1A), which may be connected to one another via an X2 interface (e.g., backhaul) (not shown).

In various embodiments, each eNodeB may provide to wireless devices an access point to an LTE core (e.g., an Evolved Packet Core). For example, the EPS in the network architecture 150 may further include an Evolved Packet Core (EPC) 154 to which the E-UTRAN 152 may connect. In various embodiments, the EPC 154 may include at least one Mobility Management Entity (MME) 162, a Serving Gateway (SGW) 160, and a Packet Data Network (PDN) Gateway (PGW) 163.

In various embodiments, the E-UTRAN 152 may connect to the EPC 154 by connecting to the SGW 160 and to the MME 162 within the EPC 154. The MME 162, which may also be logically connected to SGW 160, may handle tracking and paging of the wireless communication device 102 and security for E-UTRAN access on the EPC 154. The MME 162 may be linked to a Home Subscriber Server (HSS) 156, which may support a database containing user subscription, profile, and authentication information. Further, the MME 162 provides bearer and connection management for user IP packets, which are transferred through the SGW 160. In various embodiments, the SGW 160 may be connected to the PGW 163, which may provide IP address allocation to the wireless communication device 102, as well as other functions. The PGW 163 may be connected

The PGW 163 may connect to packet data networks, through which IP services provided by the network operator may be accessed. For example, the PGW 163 may be connected to at least an IP Multimedia Subsystem (IMS) and the Internet (IMS/Internet 158) in various embodiments. Other example packet data networks may include enterprise VPNs, content delivery networks, etc.

The network architecture 150 may also include trusted and/or untrusted WLANs (e.g., Wi-Fi networks). The wireless communication device 102 may connect to a trusted WLAN 180 and/or an untrusted WLAN 182 by connecting to corresponding wireless access points (e.g., 122). In particular, the EPC 154 may include a Trusted Wireless Access Gateway (TWAG) 186 to which the trusted WLAN 180 may connect, and an Evolved Packet Data Gateway (ePDG) 188 to which the untrusted WLAN 182 may connect. Details about the inclusion of these entities are specified in the LTE standards, such as 3GPP Technical Specification 23.402 version 10.4.0 Release 10, entitled “Architecture Enhancements for non-3GPP Services.”

In various embodiments, the TWAG 186 and the ePDG 188 may each perform a variety of functions to enable access to the EPC through WLANs. Such functions may include, for example, providing secure tunneling and aggregation of traffic from a wireless access point, authenticating the wireless communication device, providing a secure tunneling mechanism to the PGW 163 (e.g., using GPRS Tunneling Protocol (GTP) or Proxy Mobile IPv6 (PMIP)), creating a session request for bearer establishment, and performing voice-over WLAN call data forwarding between the PGW and the trusted WLAN 180 or untrusted WLAN 182. Thus, the wireless communication device 102 may access the IP services provided by the network operator through the WLAN 180 and/or the untrusted WLAN 182. In various embodiments, such IP services may include, but are not limited to, voice and video calling, and may be provided through various packet data networks (e.g., IMS/Internet 158).

The network architecture 150 may also include circuit-switched (CS) and packet-switched (PS) networks. In some embodiments, the wireless communication device 102 may be connected to the CS and/or PS packet switched networks by connecting to a legacy second generation (2G)/third generation (3G) access network 164, which may be one or more UTRAN, GSM Enhanced Data rates for Global Evolution (EDGE) Radio Access Network (GERAN), etc. In the various embodiments, the 2G/3G access network 164 may include a network of base stations (e.g., base transceiver stations (BTSs), nodeBs, radio base stations (RBSs), etc.) (e.g., 110), as well as at least one base station controller (BSC) or radio network controller (RNC). In various embodiments, the 2G/3G access network 164 may connect to the circuit switched network via an interface with (or gateway to) a Mobile switching center (MSC) and associated Visitor location register (VLR), which may be implemented together as MSC/VLR 166. In the CS network, the MSC/VLR 166 may connect to a CS core 168, which may be connected to external networks (e.g., the public switched telephone network (PSTN)) through a Gateway MSC (GMSC) 170.

In various embodiments, the 2G/3G access network 164 may connect to the PS network via an interface with (or gateway to) a Serving GPRS support node (SGSN) 172, which may connect to a PS core 174. In the PS network, the PS core 174 may be connected to external PS networks, such as the Internet and the Operator's IP services 158 through a Gateway GPRS support node (GGSN) 176.

A number of techniques may be employed by LTE network operators to enable voice calls to the wireless communication device 102 when camped on the LTE network (e.g., EPS). The LTE network (e.g., EPS) may co-exist in mixed networks with the CS and PS networks, with the MME 162 serving the wireless communication device 102 for utilizing PS data services over the LTE network, the SGSN 172 serving the wireless communication device 102 for utilizing PS data services in non-LTE areas, and the MSC/VLR 166 serving the wireless communication device 102 for utilizing voice services. In various embodiments, the wireless communication device 102 may be able to use a single RF resource for both voice and LTE data services by implementing circuit-switched fallback (CSFB) to switch between accessing the E-UTRAN 152 and the legacy 2G/3G access network 164.

The mixed network may be configured to facilitate circuit switched fallback (CSFB) via an interface (SGs) between the MME 162 and the MSC/VLR 166. The interface enables the wireless communication device 102 to utilize a single RF resource to be both CS and PS registered while camped on the LTE network, which enables delivery CS pages via the E-UTRAN 152. A CS page may initiate the CSFB procedure, which may cause the wireless device to transition to the CS network and utilize the CS call setup procedures.

Modulation and multiple access schemes may be employed by a high speed access network (e.g., E-UTRAN 152), and may vary depending on the particular telecommunications standard being deployed. For example, in LTE applications, orthogonal frequency-division multiplexing (OFDM) may be used on the downlink, while single-carrier frequency-division multiple access (SC-FDMA) may be used on the uplink to support both frequency division duplexing (FDD) and time division duplexing (TDD).

Various embodiments that are described with respect to LTE may be extended to other telecommunication standards employing other modulation and multiple access techniques. By way of example, various embodiments may be extended to Evolution-Data Optimized (EV-DO) and/or Ultra Mobile Broadband (UMB), each of which are air interface standards promulgated by the 3rd Generation Partnership Project 2 (3GPP2) as part of the CDMA2000 family to provide broadband Internet access to wireless devices. Various embodiments may also be extended to Universal Terrestrial Radio Access (UTRA) employing Wideband-CDMA (W-CDMA), GSM, Evolved UTRA (E-UTRA), Ultra Mobile Broadband (UMB), Institute of Electrical and Electronics Engineers (IEEE) 802.11 (Wi-Fi), IEEE 802.16 (WiMAX), IEEE 802.20, and/or Flash-OFDM employing Orthogonal Frequency-Division Multiple Access (OFDMA). The actual wireless communication standard and the RAT employed depend on the specific application and the overall design constraints imposed on the system.

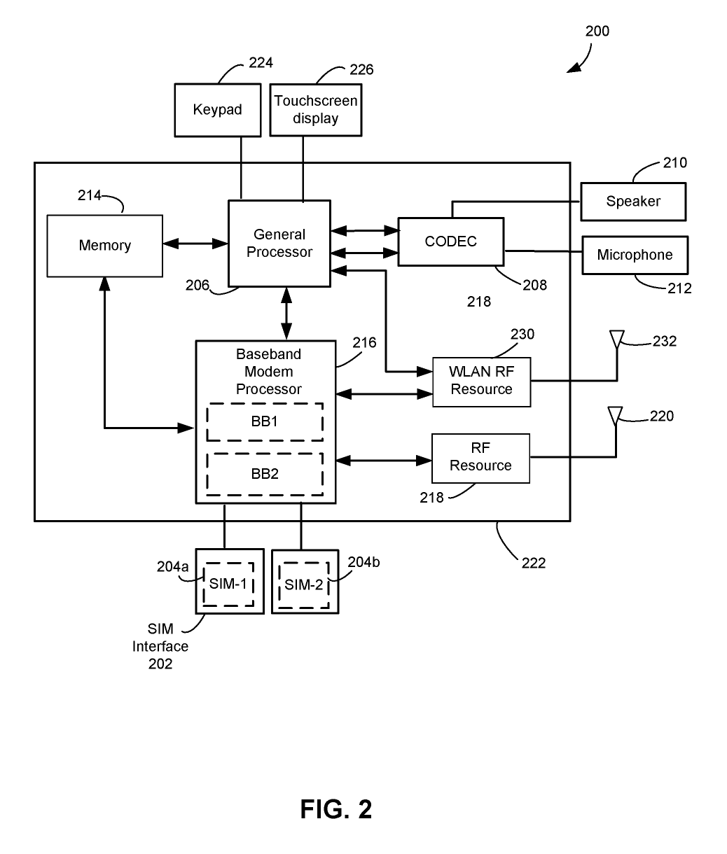

FIG. 2 is a functional block diagram of an example wireless communication device 200 that is suitable for implementing various embodiments. With reference to FIGS. 1A-2, the wireless communication device 200 may be similar to one or more of the wireless device 102. The wireless communication device 200 may be a multi-SIM wireless communication device, such as an MSMS wireless communication device. The wireless device 200 may include at least one SIM interface 202, which may receive a first SIM (“SIM-1”) 204a that is associated with a first subscription. In some embodiments, the at least one SIM interface 202 may be implemented as multiple SIM interfaces 202, which may receive at least a second SIM (“SIM-2”) 204b that is associated with at least a second subscription.

A SIM in various embodiments may be a Universal Integrated Circuit Card (UICC) that is configured with SIM and/or USIM applications, enabling access to GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card.

Each SIM 204a, 204b may have a CPU, ROM, RAM, EEPROM and I/O circuits. One or more of the first SIM 204a and second SIM 204b used in various embodiments may contain user account information, an IMSI a set of SIM application toolkit (SAT) commands and storage space for phone book contacts. One or more of the first SIM 204a and second SIM 204b may further store home identifiers (e.g., a System Identification Number (SID)/Network Identification Number (NID) pair, a Home PLMN (HPLMN) code, etc.) to indicate the SIM network operator provider. An Integrated Circuit Card Identity (ICCID) SIM serial number may be printed on one or more SIM 204 for identification. In some embodiments, additional SIMs may be provided for use on the wireless device 200 through a VSIM application (not shown). For example, the VSIM application may implement remote SIMs on the wireless device 200 by provisioning corresponding SIM profiles.

The wireless device 200 may include at least one controller, such as a general-purpose processor 206, which may be coupled to a coder/decoder (CODEC) 208. The CODEC 208 may in turn be coupled to a speaker 210 and a microphone 212. The general purpose processor 206 may also be coupled to at least one memory 214. The memory 214 may be a non-transitory tangible computer readable storage medium that stores processor-executable instructions. For example, the instructions may include routing communication data relating to a subscription though the transmit chain and receive chain of a corresponding baseband-RF resource chain. The memory 214 may store operating system (OS), as well as user application software and executable instructions. The general purpose processor 206 and memory 214 may each be coupled to at least one baseband-modem processor 216. Each SIM 204a, 204b in the wireless device 200 may be associated with a baseband-RF resource chain that includes at least one baseband-modem processor 216 and at least one RF resource 218.

In some embodiments, the wireless device 200 may be an MSMS device, such as a DSDS device, with both SIMs 204a, 204b sharing a single baseband-RF resource chain that includes the baseband-modem processor 216—which may perform baseband/modem functions for communicating with/controlling a radio access technology—and an RF resource 218. In some embodiments, the shared baseband-RF resource chain may include, for each of the first SIM 204a and the second SIM 204b, separate baseband-modem processor 216 functionality (e.g., BB1 and BB2).

The RF resource 218 may include receiver and transmitter circuitry coupled to at least one antenna 220, and configured to perform transmit/receive functions for the wireless services associated with each SIM 204a, 204b of the wireless device 200. The RF resource 218 may implement separate transmit and receive functionalities, or may include a transceiver that combines transmitter and receiver functions. The RF resource 218 may be configured to support multiple radio access technologies/wireless networks that operate according to different wireless communication protocols. The RF resource 218 may include or provide connections to different sets of amplifiers, digital to analog converters, analog to digital converters, filters, voltage controlled oscillators, etc.

The wireless communication device may also include a WLAN RF resource 230 coupled to an antenna 232 for supporting wireless communications with a WLAN, such as a Wi-Fi network. The WLAN RF resource 230 may be coupled to the general processor 206 to support data communications via the W LAN with a remote network (e.g., the Internet). The W LAN RF resource 230 may also be coupled to the baseband modem processor 216 to support VoWLAN communications as well as data communications using LTE protocols.

As described above, a wireless communication device in the various embodiments may support a number of radio access technologies (RATs). For example, the radio technologies may include a wide area network (e.g., using an LTE network, a wireless local area network (WLAN), a Bluetooth network and/or the like). Multiple antennas 220 and/or receive blocks may be provided to facilitate multimode communication with various combinations of antenna and receiver/transmitter configurations.

The baseband-modem processor of a wireless communication device may be configured to execute software including at least one modem stack associated with at least one SIM. SIMs and associated modem stacks may be configured to support a variety of communication services that fulfill different user requirements. Further, a particular SIM may be provisioned with information to execute different signaling procedures for accessing a domain of the core network associated with these services and for handling data thereof.

In some embodiments, the general purpose processor 206, memory 214, baseband-modem processor 216, and RF resource 218 may be included in a system-on-chip device 222. The first and second SIMs 204a, 204b and their corresponding interface(s) 202 may be external to the system-on-chip device 222. Further, various input and output devices may be coupled to components of the system-on-chip device 222, such as interfaces or controllers. Example user input components suitable for use in the wireless device 200 may include, but are not limited to, a keypad 224 and a touchscreen display 226.

In some embodiments, the keypad 224, touchscreen display 226, microphone 212, or a combination thereof, may perform the function of receiving the request to initiate an outgoing call. For example, the touchscreen display 226 may receive a selection of a contact from a contact list or receive a telephone number. In another example, either or both of the touchscreen display 226 and microphone 212 may perform the function of receiving a request to initiate an outgoing call. For example, the touchscreen display 226 may receive selection of a contact from a contact list or to receive a telephone number. As another example, the request to initiate the outgoing call may be in the form of a voice command received via the microphone 212. Interfaces may be provided between the various software modules and functions in the wireless device 200 to enable communication between them, as is known in the art.

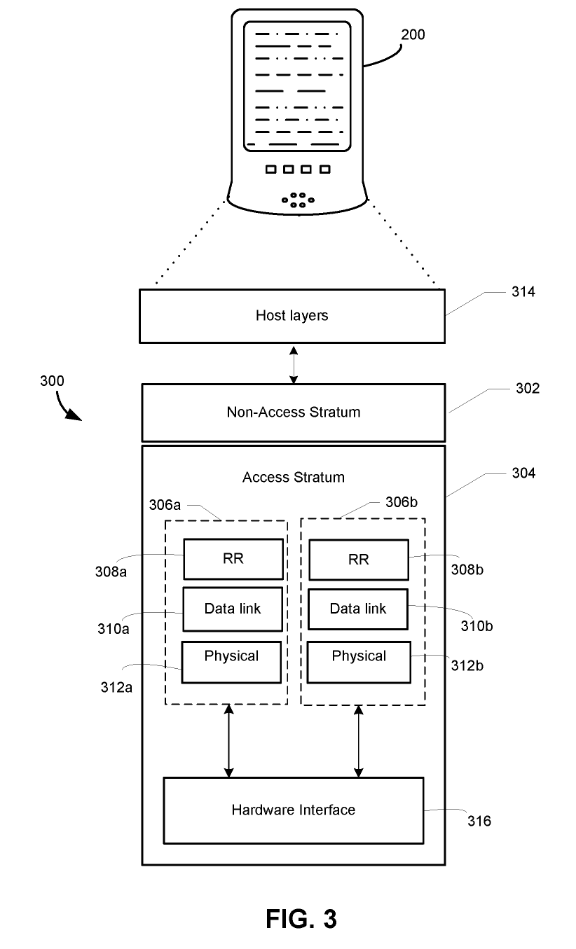

FIG. 3 illustrates an example of a software architecture with layered radio protocol stacks that may be used in data communications on an MSMS wireless communication device. Referring to FIGS. 1A-3, the wireless communication device 200 may have a layered software architecture 300 to communicate over access networks associated with SIMs. The software architecture 300 may be distributed among one or more processors, such as a baseband-modem processor (e.g., 216). The software architecture 300 may also include a Non Access Stratum (NAS) 302 and an Access Stratum (AS) 304. The NAS 302 may include functions and protocols to support traffic and signaling each SIM of the wireless communication device 200 (e.g., SIM-1 204a, SIM-2 204b) and their respective core networks. The AS 304 may include functions and protocols that support communication between each SIM (e.g., the SIM-1 204a, SIM-2 204b)) and entities of their respective access networks (e.g., a MSC in a GSM network, eNodeB in an LTE network, etc.).

In the wireless communication device 200, the AS 304 may include multiple protocol stacks, each of which may be associated with a different SIM. For example, the AS 304 may include protocol stacks 306a, 306b, associated with the first and second SIMs 204a, 204b, respectively. Although described below with reference to GSM-type communication layers, protocol stacks 306a, 306b may support any of variety of standards and protocols for wireless communications. In particular, the AS 304 may include at least three layers, each of which may contain various sublayers. For example, each protocol stack 306a, 306b may respectively include a Radio Resource (RR) sublayer 308a, 308b as part of Layer 3 (L3) of the AS 304 in a GSM or LTE signaling protocol. The RR sublayers 308a, 308b may oversee the establishment of a link between the wireless communication device 200 and associated access networks. In the various embodiments, the NAS 302 and RR sublayers 308a, 308b may perform the various functions to search for wireless networks and to establish, maintain and terminate calls. Further, the RR sublayers 308a, 308b may provide functions including broadcasting system information, paging, and establishing and releasing a radio resource control (RRC) signaling connection between a multi-SIM wireless communication device 200 and the associated access network.

While not shown, the software architecture 300 may include additional Layer 3 sublayers, as well as various upper layers above Layer 3. Additional sub-layers may include, for example, connection management (CM) sub-layers (not shown) that route calls, select a service type, prioritize data, perform QoS functions, etc.

Residing below the Layer 3 sublayers (RR sublayers 308a, 308b), the protocol stacks 306a, 306b may also include data link layers 310a, 310b, which may be part of Layer 2 in a GSM or LTE signaling protocol. The data link layers 310a, 310b may provide functions to handle incoming and outgoing data across the network, such as dividing output data into data frames and analyzing incoming data to ensure the data has been successfully received In some embodiments, each data link layer 310a, 310b may contain various sublayers, such as a media access control (MAC) sublayer, a radio link control (RLC) sublayer, and a packet data convergence protocol (PDCP) sublayer, each of which form logical connections terminating at the access network. In various embodiments, a PDCP sublayer may provide uplink functions including multiplexing between different radio bearers and logical channels, sequence number addition, handover data handling, integrity protection, ciphering, and header compression. In the downlink, the PDCP sublayer may provide functions that include in-sequence delivery of data packets, duplicate data packet detection, integrity validation, deciphering, and header decompression.

In the uplink, the RLC sublayer may provide segmentation and concatenation of upper layer data packets, retransmission of lost data packets, and Automatic Repeat Request (ARQ). In the downlink, the RLC sublayer functions may include reordering of data packets to compensate for out-of-order reception, reassembly of upper layer data packets, and ARQ. In the uplink, the MAC sublayer may provide functions including multiplexing between logical and transport channels, random access procedure, logical channel priority, and hybrid-ARQ (HARQ) operations. In the downlink, the MAC layer functions may include channel mapping within a cell, de-multiplexing, DRX, and HARQ operations.

Residing below the data link layers 310a, 310b, the protocol stacks 306a, 306b may also include physical layers 312a, 312b, which may establish connections over the air interface and manage network resources for the wireless communication device 200. In various embodiments, the physical layers 312a, 312b may oversee functions that enable transmission and/or reception over the air interface. Examples of such physical layer functions may include cyclic redundancy check (CRC) attachment, coding blocks, scrambling and descrambling, modulation and demodulation, signal measurements, MIMO, etc.

While the protocol stacks 306a, 306b provide functions to transmit data through physical media, the software architecture 300 may further include at least one host layer 314 to provide data transfer services to various applications in the wireless communication device 200. In other embodiments, application-specific functions provided by the at least one host layer 314 may provide an interface between the protocol stacks 306a, 306b and the general processor 206. In some embodiments, the protocol stacks 306a, 306b may each include one or more higher logical layers (e.g., transport, session, presentation, application, etc.) that provide host layer functions. For example, in some embodiments, the software architecture 300 may include a network layer (e.g., IP layer) in which a logical connection terminates at a gateway (e.g., PGW 163). In some embodiments, the software architecture 300 may include an application layer in which a logical connection terminates at another device (e.g., end user device, server, etc.). In some embodiments, the software architecture 300 may further include in the AS 304 a hardware interface 316 between the physical layers 312a, 312b and the communication hardware (e.g., one or more RF resource).

In various embodiments, the protocol stacks 306a, 306b of the layered software architecture may be implemented to allow modem operation using information provisioned on multiple SIMs. Therefore, a protocol stack that may be executed by a baseband-modem processor is interchangeably referred to herein as a modem stack.

The modem stacks in various embodiments may support any of a variety of current and/or future protocols for wireless communications. For examples, the modem stacks in various embodiments may support networks using radio access technologies described in 3GPP standards (e.g., GSM, UMTS, LTE, etc.), 3GPP2 standards (e.g., 1×RTT/CDMA2000, EV-DO, UMB, etc.) and/or IEEE standards (WiMAX, Wi-Fi, etc.).

Various embodiments may implement a method for improving performance in a multi-SIM wireless communication device when at least two SIMs (or modem stacks associated with at least two SIMs) are operating in idle mode using DRX. Specifically, various embodiments may avoid overlaps in the predicted timing of the active periods associated with each SIM so that information sent on their respective paging channels may be decoded. In various embodiments, the wireless communication device may shift the DRX cycle of a SIM that is registered with an IMS for VoWLAN in order to avoid such timing overlaps without degrading performance in receiving mobile terminating calls for either SIM.

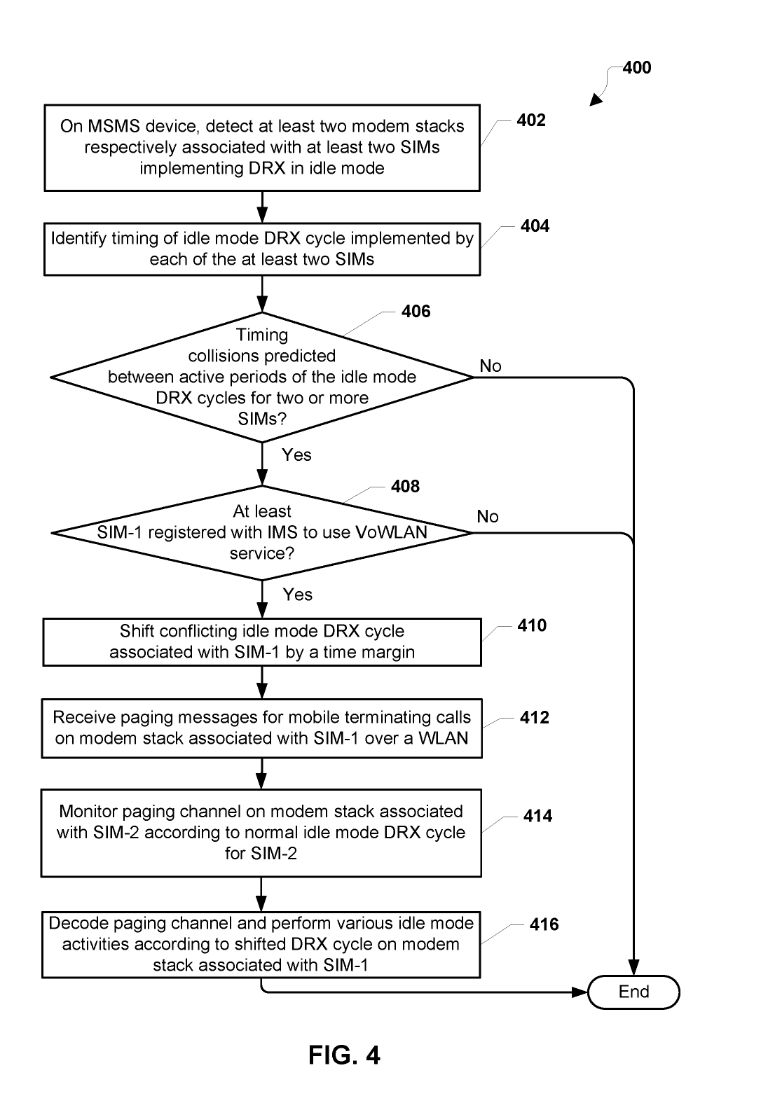

FIG. 4 illustrates a method 400 for using VoWLAN capabilities to maintain performance for mobile terminating calls on multiple idle mode SIMs according to various embodiments. With reference to FIGS. 1A-4, the operations of the method 400 may be implemented by one or more processors of a wireless device, such as the wireless communication device 200. The one or more processors may include, for example, a general purpose processor 206 and/or a baseband modem processor(s) 216, or a separate controller (not shown) that may be coupled to the memory 214 and to the baseband modem processor(s) 216.

While the various embodiments describe improving page decode performance with respect to two SIMs associated with one RF resource, the various embodiment processes may be implemented for SIM functions on more than two SIMs (e.g., three SIMs, four SIMs, etc.). Further, the use of more than two SIMs in various embodiments may involve sharing more than one RF resource (e.g., two shared RF resources, three shared RF resources, etc.).

References to the first SIM (“SIM-1”) and associated modem stack, and the second SIM (“SIM-2”) and associated modem stack, are arbitrary and used merely for the purposes of describing the embodiments. The wireless device processor may assign any indicator, name, or other designation to differentiate the SIMs, associated modem stacks, and network resources. Further, embodiment methods may apply the same regardless of the mobility state of each SIM and/or communication activity on the modem stack associated with each SIM.

In block 402, the wireless device processor may detect that at least two modem stacks respectively associated with idle mode SIMs of a MSMS device are implementing DRX. In various embodiments, each of the idle mode SIMs may support a plurality of radio access technologies provided by a mobile network operator (e.g., GSM, WCDMA, LTE, etc.).

In block 404, the wireless device processor may identify the timing of the idle mode DRX cycle implemented by each of the at least two SIMs. The duration of a DRX cycle associated with a particular SIM depends on the network in which it is camped and the supported radio access technology. In some embodiments, a modem stack associated with a SIM that supports multiple radio access technologies may be camped in a network that supports one radio access technology, which controls the DRX cycle duration. In some embodiments, depending on the network operator, a modem stack associated with a SIM that supports multiple radio access technologies may be camped in a hybrid network using two radio access technologies, each of which may have an idle mode DRX cycle duration. The network may broadcast the idle mode DRX configurations in system information (e.g., SIB2 in LTE), which may be used to calculated the paging frame number (i.e., radio frame containing the paging occasion for the SIM) and the paging subframe (i.e., the particular subframe within the paging frame that contains the paging occasion for the SIM). In various embodiments, identifying the timing of a DRX cycle may include identifying both the DRX cycle length (i.e., number of radio frames) and calculating the paging frame and paging occasion.

In determination block 406, the wireless device processor may determine whether timing collisions are predicted between active periods of the idle mode DRX cycles for two or more SIMs. That is, using DRX cycle lengths and paging frame numbers, the wireless device processor may determine whether the active periods (i.e., periods in awake state) associated with the SIMs in idle mode are scheduled to overlap in time.

In response to determining that timing collisions are not predicted between active periods of the idle mode DRX cycles for two or more SIMs (i.e., determination block 406=“No”), the wireless device processor may proceed with normal idle mode operations on the modem stacks associated with each SIM.

In response to determining that timing collisions are predicted between active periods of the idle mode DRX cycles for two or more SIMs (i.e., determination block 406=“Yes”), the wireless device processor may determine whether at least a first SIM is registered with an IMS to use VoWLAN service in determination block 408. Specifically, various multimedia services in LTE may be provided by an IMS packet data network, including voice-over-wireless local area network (VoWLAN). The VoWLAN service enables voice calls to be made and received through a WLAN connection, such as a Wi-Fi access point. Therefore, an idle mode SIM that supports LTE may have an IMS service profile indicating features for voice media, and be registered with a particular IP address that is used by a VoWLAN (e.g., VoWi-Fi) session initiated protocol (SIP) user agent configured on the device.

In response to determining that none of the at least two SIMs are registered with an IMS to use VoWLAN service (i.e., determination block 408=“No”), the wireless device processor may proceed with normal operations on the modem stacks associated with each idle mode SIM. That is, any collisions in active periods of the idle mode DRX cycles associated with two or more SIMs may be handled through normal RF resource arbitration on the wireless communication device.

In response to determining that at least a first SIM is registered with an IMS to use a VoWLAN service (i.e., determination block 408=“Yes”), the wireless device processor may shift the conflicting idle mode DRX cycle associated with the first SIM by a time margin in block 410. In various embodiments, the time margin value may be predetermined, or may be developed dynamically over time as a minimum time shift required to avoid page decode performance degradation. In some embodiments, the time margin value may be configurable on the wireless communication device. In some embodiments, the time margin value may be set by the serving network based on various criteria and/or using a default value.

In block 412, the wireless device processor may receive pages for mobile terminating calls on the modem stack associated with the first SIM over a WLAN (e.g., a Wi-Fi network). That is, since connection to the WLAN is not tied to the timing of the DRX cycle(s) implemented for any of the wireless service provider's networks (e.g., GSM, WCDMA, LTE, etc.), mobile terminating call pages to the first SIM may be received over the WLAN at any time regardless of the connectivity state/mode in the supported RAT(s).

In block 414, the wireless device processor may monitor the paging channel on the modem stack associated with the second SIM according to the normal idle mode DRX cycle for the second SIM.

In block 416, the wireless device processor may decode the paging channel and perform various idle mode activities of the serving network according to the shifted DRX cycle on the modem stack associated with the first SIM. Specifically, although pages for mobile terminating calls to the first mode SIM may be received over the WLAN, the wireless device processor may still need to receive information broadcast on the paging channel by the serving network (i.e., the wireless service provider's network in which the first SIM is camped) in order to perform other idle-mode tasks. For example, the wireless device processor may monitor the paging channel to decode system information changes, receive any indications of messages from the ETWS or CMAS, perform signal measurements, etc. on the modem stack associated with the first SIM. Since the serving network broadcasts this general information for all paging groups, the modem stack associated with the first SIM may use the shifted DRX cycle without impacting performance.

In various embodiments, operations in blocks 412 and 414 may occur in any order, and/or at the same time since the conflict between idle mode DRX cycles for the first and second SIMs has been removed.

Since pages for mobile terminating calls may be received over WLAN, in various embodiments the increased power consumption that results from decoding the paging channel in the shifted DRX cycle for the modem stack associated with the first SIM may be avoided. That is, the wireless communication device may implement a power saving scheme to reduce or stop decoding the paging channel when pages for the first idle mode SIM are received over a WLAN.

Specifically, when VoWLAN capability is enabled, maintaining synchronization with the serving network on the first SIM may be needed only for limited purposes. For example, in idle mode, such network synchronization may ensure that the modem stack associated with the first SIM is camped in the strongest available cell to resume receiving normal idle mode paging messages in case the WLAN signal drops out. In connected mode, such network synchronization may enable mobility (i.e., for potential voice call hand-off, etc.). Therefore, while the modem stack associated with the first SIM may still require certain broadcast information to be received from the network on the paging channel, such information may be received without maintaining network synchronization. Thus, in various embodiments, the power saving scheme may involve minimizing decoding the paging channel as long as at least one of the WLAN signal and the LTE signal is above a threshold level. In this manner, the modem stack associated with the first SIM may only decode the paging channel when necessary to receive system information update notifications and/or indications of messaging from the ETWS.

System information in LTE may only be changed at specific radio frames defined by a modification period. When system information is going to be changed, an LTE network may broadcast a change notification within the current modification period, followed by sending the new system information upon the start of the next modification period (i.e., the modification boundary). That is, upon receiving the change notification message during a first modification period, a wireless communication device may continue to use the current system information until the end of the current modification period, and acquires new system information after the modification boundary. For example, the change notification message may be an information element (e.g., SystemInfoModification in LTE) that is broadcast on the paging channel within the modification period, which indicates that the system information will change at the start of the next modification period. The SystemInfoModification information element may be repeated until the end of the modification period so that the change in the system information is acquired by all devices. In some embodiments, the duration of the modification period may be a multiplier of the idle mode DRX cycle, and may broadcast from the network in SIB2.

Based on the modification period duration, in some embodiments the modem stack associated with the first SIM may implement a power saving scheme by skipping decoding the paging channel in all of the DRX cycles except for the cycle immediately prior to the modification boundary. For example, the idle mode DRX cycle implemented by the serving network of the first idle mode SIM may have a duration of 640 ms, and the modification period may have a duration of 5120 ms (i.e., eight DRX cycles). As such, the modem stack of the first idle mode SIM may go through eight awake periods with paging occasions within the same modification period.

Instead of decoding the paging channel for all eight paging occasions, the modem stack associated with the first SIM in various embodiments may refrain from decoding the first seven paging occasions, and decode only the last paging occasion before the end of the current modification period (i.e., modification boundary). While eight is used as an example multiplier of the idle mode DRX cycle, the reduction in paging channel decodes may be applied for any modification period having a multiplier greater than two to skip at least one paging occasion per period.

Thus, in some embodiments, the power saving scheme may be implemented when the signal strength of the WLAN network on which paging messages for mobile terminating calls to the first SIM are configured to be transmitted is above a WLAN threshold, and/or the signal strength of the network on which the first SIM is camped (i.e., serving network) is above a network signal threshold. In various embodiments, the strength of a signal received from the WLAN or the serving network may be measured, for example, using Received Channel Power Indicator (RCPI), Received Signal Strength Indicator (RSSI), Reference Signal Received Power (RSRP), or other parameter. As described, the power saving scheme may be performed by decoding the paging channel for only the last paging occasion prior to the modification boundary associated with the network, rather than decoding the paging channel during the active period of each DRX cycle. As such, the paging channel is only decoded during a subframe in which a change notification message, if sent by the network, will be included. In this manner, the power usage by the wireless communication device may be significantly reduced, while the change notification message is still received from the serving network in advance of the next modification period.

In some embodiments, the change notification message may be provided as part of a system information block (SIB), which may be additionally or alternatively received by the modem stack associated with the first SIM if it has entered the RRC connected mode. Specifically, in an LTE system, the value of a system information tag in SIB1 is incremented by the network following each change in system information. Therefore, to implement a power saving scheme, the modem stack associated with the first SIM may skip all paging occasions for an LTE network to which an RRC connection is established, and may instead decode SIB1 after the start of a new modification period to obtain the system information tag value. The modem stack associated with the first SIM may compare the value of the system information tag to a previously stored value in order to determine whether system information was changed at the start of the current modification period.

If it is determined that the system information has been changed by the network, the modem stack associated with the first SIM may invalidate the current system information and reacquire the system information from the network. In this manner, the power usage by the wireless communication device may be even further reduced, while still providing a mechanism through which the change in system information is discovered. Moreover, since the modem stack associated with the first SIM is in the RRC connected mode, additional broadcast information that would be indicated on the paging channel may be received from the serving network in system information (e.g., messages from ETWS in SIB10 and SIB11 for LTE).

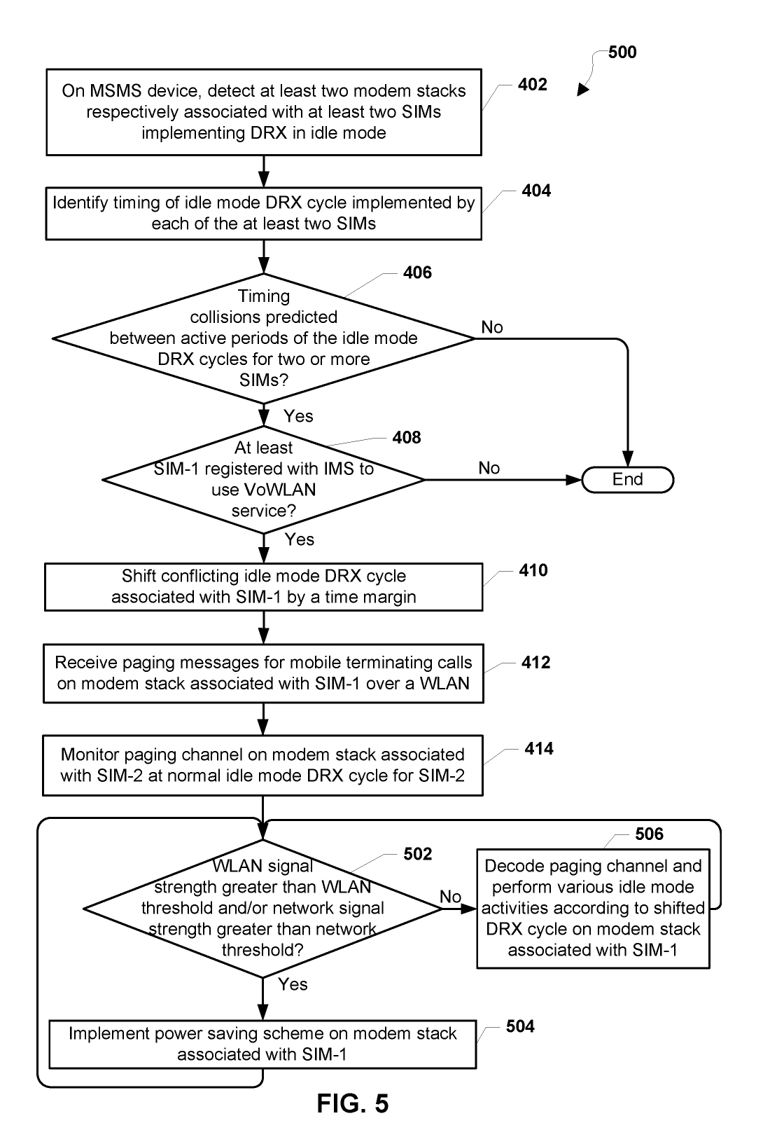

FIG. 5 illustrates another method 500 for using VoWLAN capabilities to maintain performance for mobile terminating calls on multiple idle mode SIMs according to various embodiments. With reference to FIGS. 1A-5, the operations of the method 500 may be implemented by one or more processors of a wireless device, such as the wireless communication device 200. The one or more processors may include, for example, a general purpose processor 206 and/or a baseband modem processor(s) 216, or a separate controller (not shown) that may be coupled to the memory 214 and to the baseband modem processor(s) 216.

In the method 500, the wireless device processor may perform the operations of blocks 402-414 of the method 400 as described with reference to FIG. 4. In block 502 the wireless device processor may determine whether the signal strength of the WLAN network on which mobile terminating call paging messages to the first SIM are configured to be sent is above a WLAN threshold, and/or the signal strength of the serving network (e.g., an LTE network) for the first SIM is above a network threshold. In response to determining that the WLAN signal strength is above the WLAN threshold and/or the serving network signal strength is above the network threshold (i.e., determination block 502=“Yes”), the wireless device processor may implement a power saving scheme on the modem stack associated with the first SIM in block 504.

As described, implementing the power saving scheme on the modem stack associated with the first SIM may involve, for example, identifying a modification period for the serving network of the first SIM. Decoding the paging channel from the serving network of the first SIM only during the last power saving scheme may be performed on the modem stack associated with the first SIM by decoding the paging channel only during the last shifted DRX cycle before a modification boundary. In another example, if the modem stack associated with the first SIM has established an RRC connection with the serving network, implementing the power saving scheme may include identifying a modification period for the serving network of the first SIM, and decoding system information (i.e., SIB1 in LTE) after the start of a new modification period to obtain a value indicating whether system information has been updated. In another example, if the modem stack associated with the first SIM has established an RRC connection with the serving network, implementing the power saving scheme may involve choosing one of the mechanisms for reducing or eliminating decoding the paging channel as described.

As long as at least one of the WLAN network and the serving network has a signal strength above the corresponding threshold (i.e., determination block 502=“Yes”), the wireless device processor may continue to implement the power saving scheme in block 504.

In response to determining that the signal strengths of the WLAN network and the serving network are each below their corresponding thresholds (i.e., determination block 502=“No”), the wireless device processor may decode the paging channel according to the shifted DRX cycle on the modem stack associated with the first SIM in block 506. As long as neither of the WLAN network and the serving network has a signal strength above its corresponding threshold (i.e., determination block 502=“No”), the wireless device processor may continue to decode the paging channel and perform various idle mode activities according to the shifted DRX cycle (i.e., once per shifted DRX cycle) on the modem stack associated with the first SIM in block 506.

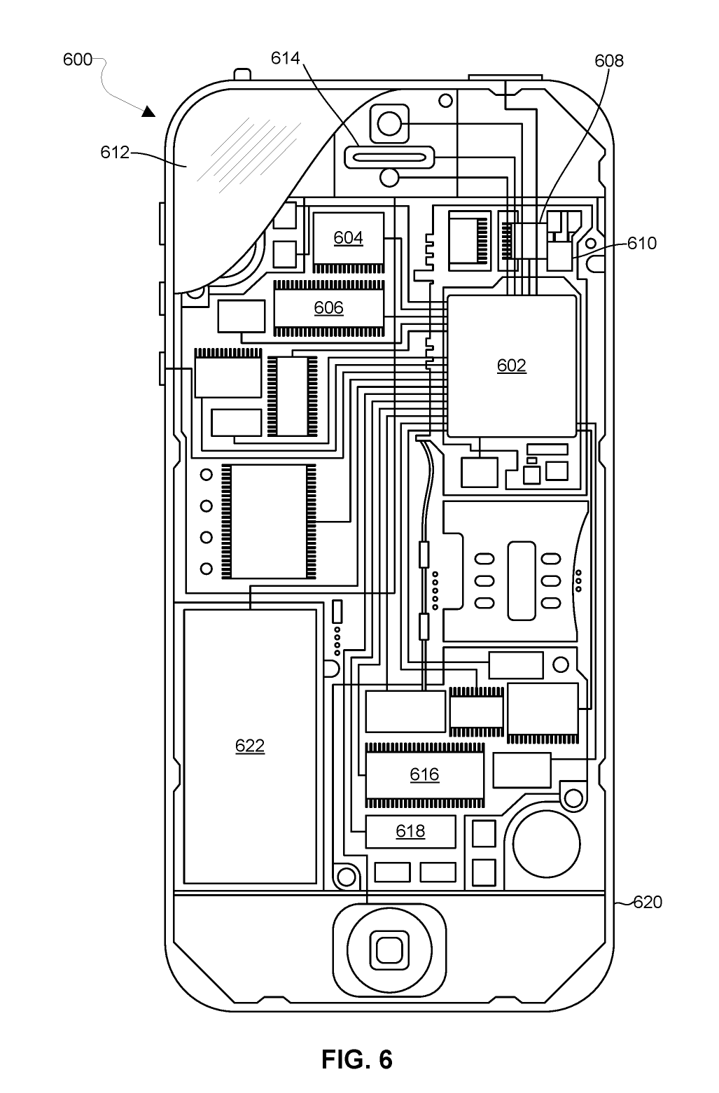

Various embodiments (including, but not limited to, the embodiments described with reference to FIGS. 4 and 5) may be implemented in any of a variety of wireless devices, an example 600 of which is illustrated in FIG. 6. With reference to FIGS. 1A-6, the wireless device 600 (which may correspond, for example, to the wireless devices 102 and/or 200 in FIGS. 1A-2) may include a processor 602 coupled to a touchscreen controller 604 and an internal memory 606. The processor 602 may be one or more multicore ICs designated for general or specific processing tasks. The internal memory 606 may be volatile or non-volatile memory, and may also be secure and/or encrypted memory, or unsecure and/or unencrypted memory, or any combination thereof.

The touchscreen controller 604 and the processor 602 may also be coupled to a touchscreen panel 612, such as a resistive-sensing touchscreen, capacitive-sensing touchscreen, infrared sensing touchscreen, etc. The wireless device 600 may have one or more radio signal transceivers 608 (e.g., Peanut®, Bluetooth®, Zigbee®, Wi-Fi, RF radio) and antennas 610, for sending and receiving, coupled to each other and/or to the processor 602. The transceivers 608 and antennas 610 may be used with the above-mentioned circuitry to implement the various wireless transmission protocol stacks and interfaces. The wireless device 600 may include a cellular network wireless modem chip 616 that enables communication via a cellular network and is coupled to the processor. The wireless device 600 may include a peripheral device connection interface 618 coupled to the processor 602. The peripheral device connection interface 618 may be singularly configured to accept one type of connection, or multiply configured to accept various types of physical and communication connections, common or proprietary, such as USB, FireWire, Thunderbolt, or PCIe. The peripheral device connection interface 618 may also be coupled to a similarly configured peripheral device connection port (not shown). The wireless device 600 may also include speakers 614 for providing audio outputs. The wireless device 600 may also include a housing 620, constructed of a plastic, metal, or a combination of materials, for containing all or some of the components discussed herein. The wireless device 600 may include a power source 622 coupled to the processor 602, such as a disposable or rechargeable battery. The rechargeable battery may also be coupled to the peripheral device connection port to receive a charging current from a source external to the wireless device 600.

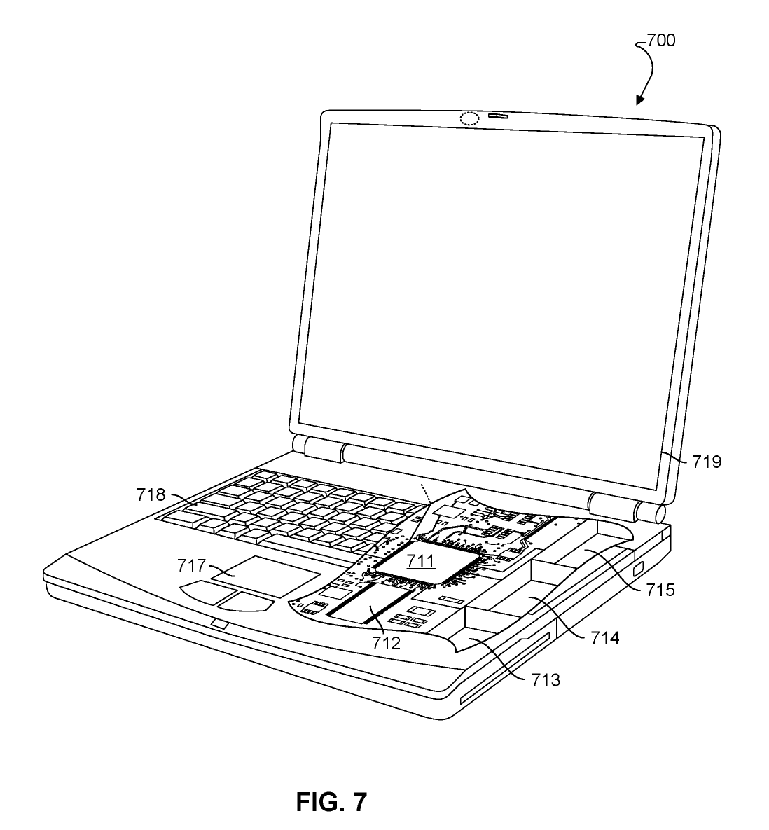

Various embodiments (including, but not limited to, the embodiments discussed above with reference to FIG. 4), may also be implemented within a variety of personal computing devices, an example 700 of which is illustrated in FIG. 7. With reference to FIGS. 1A-7, the laptop computer 700 (which may correspond, for example, to the wireless devices 102, 200 in FIGS. 1A-2) may include a touchpad touch surface 717 that serves as the computer's pointing device, and thus may receive drag, scroll, and flick gestures similar to those implemented on wireless computing devices equipped with a touchscreen display as described. A laptop computer 700 will typically include a processor 711 coupled to volatile memory 712 and a large capacity nonvolatile memory, such as a disk drive 713 of Flash memory. The computer 700 may also include a floppy disc drive 714 and a compact disc (CD) drive 715 coupled to the processor 711. The computer 700 may also include a number of connector ports coupled to the processor 711 for establishing data connections or receiving external memory devices, such as a USB or FireWire® connector sockets, or other network connection circuits for coupling the processor 711 to a network. In a notebook configuration, the computer housing includes the touchpad 717, the keyboard 718, and the display 719 all coupled to the processor 711. Other configurations of the computing device may include a computer mouse or trackball coupled to the processor (e.g., via a USB input) as are well known, which may also be used in conjunction with various embodiments.

With reference to FIGS. 1A-7, the processors 602 and 711 may be any programmable microprocessor, microcomputer or multiple processor chip or chips that can be configured by software instructions (applications) to perform a variety of functions, including the functions of various embodiments as described. In some devices, multiple processors may be provided, such as one processor dedicated to wireless communication functions and one processor dedicated to running other applications. Typically, software applications may be stored in the internal memory 606, 712 and 713 before they are accessed and loaded into the processors 602 and 711. The processors 602 and 711 may include internal memory sufficient to store the application software instructions. In many devices the internal memory may be a volatile or nonvolatile memory, such as flash memory, or a mixture of both. For the purposes of this description, a general reference to memory refers to memory accessible by the processors 602, 711, including internal memory or removable memory plugged into the device and memory within the processor 602 and 711, themselves.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

While the terms “first” and “second” are used herein to describe data transmission associated with a SIM and data receiving associated with a different SIM, such identifiers are merely for convenience and are not meant to limit the various embodiments to a particular order, sequence, type of network or carrier.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present invention is not intended to be limited to the embodiments shown herein but is to be accorded the widest scope consistent with the following claims and the principles and novel features disclosed herein.

What is claimed is:

1. A method of operating a multi-subscriber identification module (SIM) wireless communication device having at least a first SIM and a second SIM associated with a shared radio frequency (RF) resource, the method comprising:
determining whether timing collisions are predicted between an active period of a discontinuous reception (DRX) cycle associated with the first SIM and an active period of a DRX cycle associated with the second SIM;
determining whether the first SIM is registered with an IP Multimedia Subsystem (IMS) to use Voice-over-wireless local area network (VoWLAN) service over a wireless local area network (WLAN) in response to determining that timing collisions are predicted between the active period of the DRX cycle associated with the first SIM and the active period of the DRX cycle associated with the second SIM; and
in response to determining that the first SIM is registered with the IMS to use VoWLAN service over the WLAN:
shifting a conflicting DRX cycle associated with the first SIM by a time margin; and
receiving paging messages for mobile terminating calls on a modem stack associated with the first SIM over the WLAN.

2. The method of claim 1, further comprising:
decoding a paging channel of a first serving network according to the shifted DRX cycle on the modem stack associated with the first SIM; and
monitoring a paging channel of a second serving network according to the DRX cycle associated with the second SIM.

3. The method of claim 1, further comprising in response to determining that the first SIM is registered with the IMS to use the VoWLAN service:
determining whether signal strength for at least one of the WLAN and a first serving network is above a corresponding threshold; and
implementing a power saving scheme on the modem stack associated with the first SIM in response to determining that signal strength for at least one of the WLAN and the first serving network is above a corresponding threshold.

4. The method of claim 3, wherein implementing the power saving scheme comprises:
identifying a modification period associated with a first serving cell;
calculating a number of shifted DRX cycles within the modification period; and
decoding a paging channel of the first serving network only during a last shifted DRX cycle of each modification period on the modem stack associated with the first SIM.

5. The method of claim 4, wherein implementing the power saving scheme further comprises:
determining whether a notification of a change in system information is received on the paging channel of the first serving network; and
in response to determining that a notification of the change in system information is received:
invalidating current system information for the first serving network once a new modification period is started; and
receiving new system information from the first serving network.

6. The method of claim 3, wherein implementing the power saving scheme comprises:
identifying a modification period associated with the first serving network;
determining whether the first SIM has established an RRC connection with the first serving network; and
in response to determining that the first SIM has established an RRC connection with the first serving network:
decoding, on the modem stack associated with the first SIM, a system information block from a first serving cell after a new modification period has started, wherein the system information block includes a system information update tag; and
comparing a value of the system information update tag from the decoded system information block to a current value stored in the wireless communication device.

7. The method of claim 6, further comprising, in response to determining that the first SIM has established an RRC connection with the first serving network:
determining whether the value of the system information update tag from the decoded system information block is different than the current value; and
in response to determining that the value of the system information update tag from the decoded system information block is different than the current value:
invalidating current system information for the first serving network on the modem stack associated with the first SIM; and
reacquiring system information from the first serving network on the modem stack associated with the first SIM.

8. The method of claim 1, wherein the WLAN is a Wi-Fi network.

9. The method of claim 1, wherein a first serving network and a second serving network each support communications using at least Long Term Evolution (LTE), wherein the first network is different from the second network.

10. The method of claim 1, further comprising developing the time margin dynamically over time based on a minimum time shift required to avoid performance degradation in decoding paging messages on either the modem stack associated with the first SIM or the modem stack associated with the second SIM.

11. A wireless communication device, comprising:
a memory;
a radio frequency (RF) resource; and
a processor coupled to the memory and the RF resource, configured to connect to at least a first a subscriber identity module (SIM) and a second SIM, and configured with processor-executable instructions to:
determine whether timing collisions are predicted between an active period of a discontinuous reception (DRX) cycle associated with the first SIM and an active period of a DRX cycle associated with the second SIM;
determine whether the first SIM is registered with an IP Multimedia Subsystem (IMS) to use Voice-over-wireless local area network (VoWLAN) service over a wireless local area network (WLAN) in response to determining that timing collisions are predicted between the active period of the DRX cycle associated with the first SIM and the active period of the DRX cycle associated with the second SIM; and
in response to determining that the first SIM is registered with the IMS to use VoWLAN service over the WLAN:
shift a conflicting DRX cycle associated with the first SIM by a time margin; and
receive paging messages for mobile terminating calls on a modem stack associated with the first SIM over the WLAN.

12. The wireless communication device of claim 11, wherein the processor is further configured with processor-executable instructions to:
decode a paging channel of a first serving network according to the shifted DRX cycle on the modem stack associated with the first SIM; and
monitor a paging channel of a second serving network according to the DRX cycle associated with the second SIM.

13. The wireless communication device of claim 11, wherein the processor is further configured with processor-executable instructions to, in response to determining that the first SIM is registered with the IMS to use the VoWLAN service:
determine whether signal strength for at least one of the WLAN and a first serving network is above a corresponding threshold; and
implement a power saving scheme on the modem stack associated with the first SIM in response to determining that signal strength for at least one of the WLAN and the first serving network is above a corresponding threshold.

14. The wireless communication device of claim 13, wherein the processor is further configured with processor-executable instructions to implement the power saving scheme by:
identifying a modification period associated with a first serving cell;
calculating a number of shifted DRX cycles within the modification period; and
decoding a paging channel of the first serving network only during a last shifted DRX cycle of each modification period on the modem stack associated with the first SIM.

15. The wireless communication device of claim 14, wherein the processor is further configured with processor-executable instructions to implement the power saving scheme by:
determining whether a notification of a change in system information is received on the paging channel of the first serving network; and
in response to determining that a notification of the change in system information is received:
invalidating current system information for the first serving network once a new modification period is started; and
receiving new system information from the first serving network.

16. The wireless communication device of claim 13, wherein the processor is further configured with processor-executable instructions to implement the power saving scheme by:
identifying a modification period associated with the first serving network;
determining whether the first SIM has established an RRC connection with the first serving network; and
in response to determining that the first SIM has established an RRC connection with the first serving network:
decoding, on the modem stack associated with the first SIM, a system information block from a first serving cell after a new modification period has started, wherein the system information block includes a system information update tag; and
comparing a value of the system information update tag from the decoded system information block to a current value stored in the wireless communication device.

17. The wireless communication device of claim 16, wherein the processor is further configured with processor-executable instructions to:
determine whether the value of the system information update tag from the decoded system information block is different than the current value in response to determining that the first SIM has established an RRC connection with the first serving network; and
invalidate current system information for the first serving network on the modem stack associated with the first SIM and reacquire system information from the first serving network on the modem stack associated with the first SIM in response to determining that the value of the system information update tag from the decoded system information block is different than the current value.

18. The wireless communication device of claim 11, wherein the WLAN is a Wi-Fi network.

19. The wireless communication device of claim 11, wherein a first serving network and a second serving network each support communications using at least Long Term Evolution (LTE), wherein the first network is different from the second network.

20. The wireless communication device of claim 11, wherein the processor is further configured with processor-executable instructions to:
develop the time margin dynamically over time based on a minimum time shift required to avoid performance degradation in decoding paging messages on either the modem stack associated with the first SIM or the modem stack associated with the second SIM.

21. A wireless communication device, comprising:
a radio frequency (RF) resource configured to connect to at least a first subscriber identity module (SIM) and a second SIM;
means for determining whether timing collisions are predicted between an active period of a discontinuous reception (DRX) cycle associated with the first SIM and an active period of a DRX cycle associated with the second SIM;
means for determining whether the first SIM is registered with an IP Multimedia Subsystem (IMS) to use Voice-over-wireless local area network (VoWLAN) service over a wireless local area network (WLAN) in response to determining that timing collisions are predicted between the active period of the DRX cycle associated with the first SIM and the active period of the DRX cycle associated with the second SIM; and
means for shifting a conflicting DRX cycle associated with the first SIM by a time margin, and receiving paging messages for mobile terminating calls on a modem stack associated with the first SIM over the WLAN, in response to determining that the first SIM is registered with the IMS to use VoWLAN service over the WLAN.

22. A non-transitory processor-readable storage medium having stored thereon processor-executable instructions configured to cause a processor of a wireless communication device configured with a shared radio frequency (RF) to perform operations comprising:
determining whether timing collisions are predicted between an active period of a discontinuous reception (DRX) cycle associated with a first subscriber identity module (SIM) and an active period of a DRX cycle associated with a second SIM;
determining whether the first SIM is registered with an IP Multimedia Subsystem (IMS) to use Voice-over-wireless local area network (VoWLAN) service over a wireless local area network (WLAN) in response to determining that timing collisions are predicted between the active period of the DRX cycle associated with the first SIM and the active period of the DRX cycle associated with the second SIM; and
in response to determining that the first SIM is registered with the IMS to use VoWLAN service over the WLAN:
shifting a conflicting DRX cycle associated with the first SIM by a time margin; and
receiving paging messages for mobile terminating calls on a modem stack associated with the first SIM over the WLAN.

23. The non-transitory processor-readable storage medium of claim 22, wherein the stored processor-executable instructions are configured to cause the processor of the wireless communication device to perform operations further comprising:
decoding a paging channel of a first serving network according to the shifted DRX cycle on the modem stack associated with the first SIM; and
monitoring a paging channel of a second serving network according to the DRX cycle associated with the second SIM.

24. The non-transitory processor-readable storage medium of claim 22, wherein the stored processor-executable instructions are configured to cause the processor of the wireless communication device to perform operations further comprising:
determining whether signal strength for at least one of the WLAN and a first serving network is above a corresponding threshold and implementing a power saving scheme on the modem stack associated with the first SIM in response to determining that signal strength for at least one of the WLAN and the first serving network is above a corresponding threshold in response to determining that the first SIM is registered with the IMS to use the VoWLAN service.

25. The non-transitory processor-readable storage medium of claim 24, wherein the stored processor-executable instructions are configured to cause the processor of the wireless communication device to perform operations such that implementing the power saving scheme comprises:
identifying a modification period associated with a first serving cell;
calculating a number of shifted DRX cycles within the modification period; and
decoding a paging channel of the first serving network only during a last shifted DRX cycle of each modification period on the modem stack associated with the first SIM.

26. The non-transitory processor-readable storage medium of claim 25, wherein the stored processor-executable instructions are configured to cause the processor of the wireless communication device to perform operations such that implementing the power saving scheme further comprises:
determining whether a notification of a change in system information is received on the paging channel of the first serving network; and
in response to determining that a notification of the change in system information is received:
invalidating current system information for the first serving network once a new modification period is started; and
receiving new system information from the first serving network.

27. The non-transitory processor-readable storage medium of claim 24, wherein the stored processor-executable instructions are configured to cause the processor of the wireless communication device to perform operations such that implementing the power saving scheme comprises:
identifying a modification period associated with the first serving network;
determining whether the first SIM has established an RRC connection with the first serving network; and
in response to determining that the first SIM has established an RRC connection with the first serving network:
decoding, on the modem stack associated with the first SIM, a system information block from a first serving cell after a new modification period has started, wherein the system information block includes a system information update tag; and
comparing a value of the system information update tag from the decoded system information block to a current value stored in the wireless communication device.

28. The non-transitory processor-readable storage medium of claim 27, wherein the stored processor-executable instructions are configured to cause the processor of the wireless communication device to perform operations further comprising:
determining whether the value of the system information update tag from the decoded system information block is different than the current value in response to determining that the first SIM has established an RRC connection with the first serving network; and
invalidating current system information for the first serving network on the modem stack associated with the first SIM and reacquiring system information from the first serving network on the modem stack associated with the first SIM in response to determining that the value of the system information update tag from the decoded system information block is different than the current value.

29. The non-transitory processor-readable storage medium of claim 22, wherein the WLAN is a Wi-Fi network.

30. The non-transitory processor-readable storage medium of claim 22, wherein a first serving network and a second serving network each support communications using at least Long Term Evolution (LTE), wherein the first network is different from the second network.
